(19) United States
(12) Patent Application Publication
(10) Pub. No.: US 2024/0034870 A1
(43) Pub. Date: Feb. 1, 2024

(54) FLEXIBLE BUTENE-1 COPOLYMER FOR PIPES

(71) Applicant: Basell Poliolefine Italia S.r.l., Milano (IT)

(72) Inventors: Roberta Marchini, Ferrara (IT); Roberta Pica, Ferrara (IT); Stefano Spataro, Ferrara (IT)

(73) Assignee: Basell Poliolefine Italia S.r.l., Milano (IT)

(21) Appl. No.: 18/265,919

(22) PCT Filed: Dec. 10, 2021
(86) PCT No.: PCT/EP2021/085207

§ 371 Date: Jun. 7, 2023

(30) Foreign Application Priority Data
Dec. 16, 2020 (EP) 20214455.6

(51) Int. Cl. C08L 23/22

(52) U.S. Cl. CPC C08L 23/22; C08L 2203/18

(57) ABSTRACT

A copolymer of butene-1 with hexene-1 having:
1) a content of hexene-1 comonomer units from 2 to 4% by weight, based upon the total weight of the copolymer; and
2) a melting temperature TmI equal to or higher than 115° C.

### FIELD OF THE INVENTION

In general, the present disclosure relates to the field of chemistry. More specifically, the present disclosure relates to polymer chemistry. In particular, the present disclosure relates to a butene-1/hexene-1 copolymer and pipes made therefrom.

### BACKGROUND OF THE INVENTION

In some instances, butene-1 polymers perform well in the areas of pressure resistance, creep resistance, and impact strength and are used in the manufacture of pipes for replacing metal pipes.

### SUMMARY OF THE INVENTION

In a general embodiment, the present disclosure provides a copolymer of butene-1 with hexene-1 having:
1) a content of hexene-1 comonomer units from 2 to 4% by weight, alternatively from 2 to 3.5% by weight, alternatively from 2.2 to 4% by weight or from 2.2 to 3.5% by weight; and
2) a melting temperature TmI equal to or higher than 115° C., alternatively equal to or higher than 117° C.

As used herein, the term “copolymer” refers to a copolymer of butene-1 with hexene-1. The amounts of hexene-1 comonomer units are referred to the total weight of the copolymer.

### DETAILED DESCRIPTION OF THE INVENTION

In some embodiments, the copolymer is further made from or containing other olefin comonomer units, provided that the TmI is not brought to values of less than 115° C.

As such and in some embodiments, the term “copolymer” refers to polymers containing two or more kinds of monomer units other than butene-1.

In some embodiments, the copolymer consists of butene-1 units and hexene-1 units.

In some embodiments, the optional comonomer units are selected from the group consisting of ethylene, propylene, pentene-1, and alpha-olefins having from 7 to 10 carbon atoms. In some embodiments, the alpha-olefin having from 7 to 10 carbon atoms is octene-1.

In some embodiments, the copolymer has a TmI of from 115° C. to 120° C., alternatively from 117° C. to 120° C.

It is believed that the melting temperature TmI is the melting temperature attributable to the crystalline form I of the copolymer.

To determine the TmI, the copolymer sample is melted and then cooled down to 20° C. with a cooling rate of 10° C./min., kept for 10 days at room temperature, and then subjected to differential scanning calorimetry (DSC) analysis by cooling to −20° C. and then heating to 200° C. with a scanning speed corresponding to 10° C./min. In this heating run, the highest temperature peak in the thermogram is taken as the melting temperature (TmI).

In some embodiments, the copolymer has at least one of the following DSC features:
a melting temperature TmII, measured at the second DSC heating scan with a scanning speed of 10° C./minute, of from 105° C. to 109° C.; or
a crystallization temperature T_{c}, measured by DSC with a scanning speed of 10° C./minute, of from 68° C. to 75° C.

The TmII temperature values are determined after one melting cycle (second DSC heating scan).

It is believed that the TmII temperature values are attributable to the crystalline form II of the copolymer.

In some embodiments, more than one melting or crystallization peak is detected, and the temperature of the most intense peak is taken as the TmII or the T_{c}.

In some embodiments, the copolymer has a MIE of from 0.1 to 10 g/10 min., alternatively from 0.1 to 1 g/10 min., where MIE is the melt flow index measured according to ISO 1133-2:2011, at 190° C./2.16 kg.

In some embodiments, the copolymer has at least one of the following features:
an X-ray crystallinity of from 48% to 53%; or
a content of fraction soluble in xylene at 0° C. equal to or lower than 8% by weight, alternatively equal to or lower than 6% by weight, based on the total weight of the copolymer. In some embodiments, the lower limit of the content of fraction soluble in xylene at 0° C. is 3.2% by weight, based on the total weight of the copolymer.

In some embodiments, the molecular weight distribution (MWD) of the copolymer is equal to higher than 4, alternatively equal to or higher than 5, alternatively equal to or higher than 5.8, alternatively equal to or higher than 6, when expressed in terms of Mw/Mn (wherein Mw is the weight average molecular weight and Mn is the number average molecular weight), measured by GPC analysis.

In some embodiments, the upper limit of the Mw/Mn values is 9.

As used herein and in some embodiments, the term “broad MWD” refers to Mw/Mn values greater than 5.

In some embodiments, the copolymer has a Mz value of from 1,000,000 to 2,500,000 g/mol, wherein Mz is the z average molecular weight, measured by GPC analysis. In some embodiments, the previously-described Mw/Mn values are in combination with a Mz value in this range.

In some embodiments, the copolymer has a Mz/Mw value from 2 to 4.

In some embodiments, the copolymer has at least one of the following features:
a flexural modulus from 200 to 300 MPa, alternatively from 220 to 280 MPa, measured according to norm ISO 178:2019 on compressed plaques, 30 days after molding; or
a value of Izod impact resistance at 23° C. from 30 to 65 kJ/m², alternatively from 35 to 60 kJ/m², measured according to ISO180:2000 on compressed plaques according to ISO 8986-2:2009, 30 days after molding; or
a value of Izod impact resistance at 0° C. from 20 to 50 kJ/m², alternatively from 20 to 45 kJ/m², measured according to ISO180:2000 on compressed plaques according to ISO 8986-2:2009, 30 days after molding; or
an elongation at break from 250% to 350%, measured according to norm ISO 527-1:2019 on compression-molded plaques, 30 days after molding.

In some embodiments, the copolymer is obtained by low-pressure, coordination polymerization of butene-1. In some embodiments, the copolymer is obtained by polymerizing butene-1 and hexene-1 with a Ziegler-Natta catalyst based on halogenated compounds of titanium supported on magnesium chloride and a co-catalyst. In some embodiments, the comonomers for polymerization include butene-1, hexene-1, and additional comonomers. In some embodiments, the halogenated compound of titanium is TiCl₄. In some embodiments, the co-catalyst is selected from the group consisting of alkyl compounds of aluminum.

In some embodiments, the copolymer is prepared by polymerization of the monomers in the presence of a stereospecific catalyst made from or containing (i) a solid component made from or containing a Ti compound and an internal electron-donor compound supported on MgCl₂; (ii) an alkylaluminum compound; and (iii) an external electron-donor compound.

In some embodiments, magnesium dichloride in active form is used as a support. In some embodiments, Ziegler-Natta catalysts supported on magnesium dichloride in active form are used in Ziegler-Natta catalysis as described in U.S. Pat. Nos. 4,298,718 and 4,495,338. In some embodiments, the magnesium dihalides in active form used as support or co-support in components of catalysts for the polymerization of olefins, are characterized by X-ray spectra wherein the most intense diffraction line that appears in the spectrum of the non-active halide is diminished in intensity and replaced by a halo having its maximum intensity displaced towards lower angles relative to that of the more intense line.

In some embodiments, the titanium compounds used in the catalyst component (i) are selected from the group consisting of TiCl₄, TiCl₃, and Ti-haloalcoholates of formula Ti(OR)_{n-y} X_{y}, where n is the valence of titanium, X is halogen, and y is a number between 1 and n. In some embodiments, the halogen is chlorine.

In some embodiments, the internal electron-donor compound is selected from the group consisting of esters. In some embodiments, the esters are selected from the group consisting of alkyl, cycloalkyl, or aryl esters of monocarboxylic acids or polycarboxylic acids, wherein the alkyl, cycloalkyl or aryl groups having from 1 to 18 carbon atoms. In some embodiments, the monocarboxylic acids are benzoic acids. In some embodiments, the polycarboxylic acids are selected from the group consisting of phthalic acids, succinic acids, and glutaric acids. In some embodiments, the electron-donor compounds are diisobutyl phthalate, diethylphtahalate, dihexylphthalate, diethyl glutarate, diisobutyl glutarate, and 3,3-dimethyl glutarate. In some embodiments, the internal electron donor compound is used in molar ratio with respect to the MgCl₂ of from 0.01 to 1, alternatively from 0.05 to 0.5.

In some embodiments, the alkyl-Al compound (ii) is selected from the group consisting of trialkyl aluminum compounds. In some embodiments, the trialkyl aluminum compounds are selected from the group consisting of triethylaluminum, triisobutylaluminum, tri-n-butylaluminum, tri-n-hexylaluminum, and tri-n-octylaluminum. In some embodiments, the alkyl-Al compound (ii) is a mixture trialkylaluminum compounds with alkylaluminum halides, alkylaluminum hydrides, or alkylaluminum sesquichlorides. In some embodiments, the alkylaluminum sesquichlorides are selected from the group consisting of AlEt₂Cl and Al₂Et₃Cl₃.

In some embodiments, the external electron-donor compounds (iii) are silicon compounds of formula Rₐ¹R_{b}²Si(OR³)_{c}, wherein a and b are integer from 0 to 2, c is an integer from 1 to 3 and the sum (a+b+c) is 4; and R¹, R², and R³ are alkyl, cycloalkyl, or aryl radicals with 1-18 carbon atoms optionally containing heteroatoms. In some embodiments, a is 0, c is 3, b is 1, R² is a branched alkyl or cycloalkyl group, optionally containing heteroatoms, and R³ is methyl. In some embodiments, the silicon compounds are selected from the group consisting of cyclohexyltrimethoxysilane, t-butyltrimethoxysilane diisopropyltrimethoxysilane, and thexyltrimethoxysilane. In some embodiments, the silicon compound is thexyltrimethoxysilane.

In some embodiments, the electron-donor compound (iii) is used in an amount such that the molar ratio between the alkyl-Al compound (ii) and the electron donor-compound (iii) is from 0.1 to 500, alternatively from 1 to 300, alternatively from 3 to 100.

In some embodiments, the catalyst is pre-polymerized in a pre-polymerization step. In some embodiments, the prepolymerization is carried out in liquid (slurry or solution) or in the gas-phase. In some embodiments, the prepolymerization is carried out at temperatures lower than 100° C., alternatively between 20 and 70° C. The prepolymerization step is carried out with quantities of monomers, thereby obtaining the polymer in amounts of between 0.5 and 2000 g per g of solid catalyst component, alternatively between 5 and 500 g, alternatively between 10 and 100 g.

In some embodiments, the polymerization process is carried out via slurry polymerization, using as diluent a liquid inert hydrocarbon, or solution polymerization. In some embodiments, the solution polymerization uses liquid butene-1 as a reaction medium. In some embodiments, the polymerization process is carried out in the gas-phase, operating in one or more fluidized or mechanically agitated bed reactors. In some embodiments, the polymerization is carried out in liquid butene-1 as a reaction medium.

In some embodiments, the polymerization temperatures are from 20° C. to 120° C., alternatively from 40° C. to 90° C. In some embodiments, the polymerization is carried out in liquid butene-1.

In some embodiments, a molecular weight regulator is fed to the polymerization environment. In some embodiments, the molecular weight regulator is hydrogen.

In some embodiments, the polymerization catalysts and processes are as described in Patent Cooperation Treaty Publication Nos. WO99/45043 and WO2004048424.

In some embodiments, a process for preparing a copolymer with a broad MWD includes the step of copolymerizing butene-1 in the presence of a catalyst intrinsically capable of producing broad MWD copolymers. In some embodiments, a process for preparing a copolymer with a broad MWD includes the step of mechanically blending butene-1 polymers having different molecular weights.

In some embodiments, a process for preparing a copolymer with a broad MWD is a multistep polymerization process, wherein the butene-1 polymers with different molecular weights are prepared in sequence in two or more reactors with different reaction conditions. In some embodiments, the concentration of molecular weight regulator fed in each reactor differs for each reactor.

In some embodiments, the copolymer is further made from or containing additives. In some embodiments, the additives are selected from the group consisting of stabilizers, antioxidants, anticorrosion agents, processing aids, nucleating agents, pigments, organic fillers, and inorganic fillers.

In some embodiments, the copolymer is used for making pipes, alternatively UHF pipes. In some embodiments, the present disclosure provides an article of manufacture made from or containing the copolymer. In some embodiments, the article of manufacture is a pipe, alternatively a UHF pipe.

The following examples are illustrative and not intended to limit the scope of the present disclosure.

Comonomer Contents

Determined by ¹³C NMR.

¹³C NMR spectra were acquired on a Bruker AV-600 spectrometer equipped with cryo-probe, operating at 150.91 MHz in the Fourier transform mode at 120° C.

The peak of the T_{βδ} carbon (nomenclature according to C. J. Carman, R. A. Harrington and C. E. Wilkes, Macromolecules, 10, 3, 536 (1977)) was used as internal standard at 37.24 ppm. The samples were dissolved in 1,1,2,2-tetrachloroethane-d2 at 120° C. with an 8% wt/v concentration. Each spectrum was acquired with a 90° pulse, 15 seconds of delay between pulses and CPD, thereby removing ¹H-¹³C coupling. About 512 transients were stored in 32K data points using a spectral window of 9000 Hz.

Diad distribution was calculated from Sαα carbons (see Table 1) according to the following relations:

HH=A/Σ

BH=B/Σ

BB=C/Σ

Where Σ=A+B+C

The total amount of 1 butene and 1-hexene as molar percent was calculated from diad, using the following relations:

[H]=(HH+0.5 HB)*100

[B]=(BB+0.5 HB)*100

Molar composition was then transformed in weight composition using monomers molecular weight.

TABLE 1

| Area | Chemical Shift | Assignments | Sequence |
|---|---|---|---|
| A | 41.42 | Sαα | HH |
| B | 40.83 | Sαα | HB |
| C | 40.22 | Sαα | BB |
| D | 35.28 | 4B₄ | H |
| E | 35.00 | Methine | B |
| F | 33.68 | Methine | H |
| G | 29.81 | 4B₃ | H |
| H | 27.73 | 2B₂ | B |
| I | 23.49 | 4B₂ | H |
| L | 14.02 | Methyl | H |
| M | 10.86 | Methyl | B |

Melting and Crystallization Temperatures Via Differential Scanning Calorimetry (DSC)

Differential scanning calorimetric (DSC) data were obtained with a Perkin Elmer DSC-7 instrument, using a weighed sample (5-10 mg) sealed into aluminum pans.

To determine the melting temperature of the polybutene-1 crystalline form I (TmI), the sample was heated to 200° C. with a scanning speed corresponding to 10° C./minute, kept at 200° C. for 5 minutes, and then cooled down to 20° C. with a cooling rate of 10° C./min. The sample was then stored for 10 days at room temperature. After 10 days, the sample was subjected to DSC, cooled to −20° C., and then heated to 200° C. with a scanning speed corresponding to 10° C./min. In this heating run, the highest temperature peak in the thermogram, that is, the first peak temperature coming from the higher temperature side in the thermogram, was taken as the melting temperature (TmI).

To determine the melting temperature of the polybutene-1 crystalline form II (TmII) and the crystallization temperature T_{c}, the sample was heated to 200° C. with a scanning speed corresponding to 10° C./minute and kept at 200° C. for 5 minutes, thereby allowing melting of the crystallites and cancelling the thermal history of the sample. Successively, by cooling to −20° C. with a scanning speed corresponding to 10° C./minute, the peak temperature was taken as crystallization temperature (T_{c}) and the area as the crystallization enthalpy. After standing 5 minutes at −20° C., the sample was heated for the second time to 200° C. with a scanning speed corresponding to 10° C./min. In this second heating run, the peak temperature was taken as the melting temperature of the polybutene-1 crystalline form II (TmII) and the area as the melting enthalpy (ΔHfII).

Determination of X-Ray Crystallinity

The X-ray crystallinity was measured with an X-ray Diffraction Powder Diffractometer using the Cu-Kα1 radiation with fixed slits and collecting spectra between diffraction angle 2θ=5° and 2θ=35° with step of 0.1° per 6 seconds.

Measurements were performed on compression-molded specimens in the form of disks of about 1.5-2.5 mm of thickness and 2.5-4.0 cm of diameter. These specimens were obtained in a compression-molding press at a temperature of 200° C.±5° C. without applying pressure for 10 minutes, then applying a pressure of about 10 kg/cm² for about a few seconds and repeating the last operation 3 times.

The diffraction pattern was used to derive the components for the degree of crystallinity by defining a linear baseline for the spectrum and calculating the total area (Ta), expressed in counts/sec·2θ, between the spectrum profile and the baseline. Then an amorphous profile was defined, along the spectrum, that separate, according to the two-phase model, the amorphous regions from the crystalline regions. The amorphous area (Aa), expressed in counts/sec·2θ, was calculated as the area between the amorphous profile and the baseline. The crystalline area (Ca), expressed in counts/sec·2θ, was calculated as Ca=Ta−Aa.

The degree of crystallinity of the sample was then calculated according to the formula:

% Cr=100×Ca/Ta

Fractions Soluble and Insoluble in Xylene at 0° C. (XS-0° C.)

2.5 g of the polymer sample were dissolved in 250 ml of xylene at 135° C. under agitation. After 30 minutes, the solution was allowed to cool to 100° C., under agitation, and then placed in a water and ice bath to cool down to 0° C. Then, the solution was allowed to settle for 1 hour in the water and ice bath. The precipitate was filtered with filter paper. During the filtering, the flask was left in the water and ice bath, thereby keeping the flask inner temperature as near to 0° C. as possible. Once the filtering was finished, the filtrate temperature was balanced at 25° C., dipping the volumetric flask in a water-flowing bath for about 30 minutes. Then, the flask contents were divided in two 50 ml aliquots. The solution aliquots were evaporated in nitrogen flow, and the residue was dried under vacuum at 80° C. until a constant weight was reached. If the weight difference between the two residues was less than 3%, the test was terminated. If the weight difference between the two residues was not less than 3%, the test was repeated. The percent by weight of polymer soluble (Xylene Solubles at 0° C.=XS 0° C.) was calculated from the average weight of the residues. The insoluble fraction in o-xylene at 0° C. (xylene Insolubles at 0° C.=XI %0° C.) was:

XI %0° C.=100−XS %0° C.

MIE

Determined according to ISO 1133-2:2011 at 190° C. with a load of 2.16 kg.

Intrinsic Viscosity

Determined according to norm ASTM D 2857-16 in tetrahydronaphthalene at 135° C.

Mw, Mn and Mz Determination by Gel Permeation Chromatography (GPC)

The determination of the means Mn, Mw, and Mz, and of the ratio Mw/Mn derived therefrom was carried out by Gel Permeation Chromatography (GPC) in 1,2,4-trichlorobenzene (TCB) using a GPC-IR apparatus by PolymerChar, which was equipped with a column set of four PLgel Olexis mixed-bed (Polymer Laboratories) and an IR5 infrared detector (PolymerChar). The dimensions of the columns were 300×7.5 mm, and the particle size was 13 μm. The mobile phase flow rate was kept at 1.0 mL/min. The measurements were carried out at 150° C. Solution concentrations were 2.0 mg/mL (at 150° C.), and 0.3 g/L of 2,6-diterbuthyl-p-chresole were added, thereby preventing degradation. For GPC calculation, a universal calibration curve was obtained using 12 polystyrene (PS) standard samples supplied by PolymerChar (peak molecular weights ranging from 266 to 1220000). A third order polynomial fit was used to interpolate the experimental data and obtain the relevant calibration curve. Data acquisition and processing was done by using Empower 3 (Waters).

The Mark-Houwink relationship was used to determine the molecular weight distribution and the relevant average molecular weights: the K values were K_{PS}=1.21×10⁻⁴ dL/g and K_{PB}=1.78×10⁻⁴ dL/g for PS and polybutene (PB) respectively, while the Mark-Houwink exponents a=0.706 for PS and a=0.725 for PB were used.

Flexural Modulus

Determined according to norm ISO 178:2019 on compression-molded plaques, measured days after molding.

Tensile Stress and Elongation at Yield and at Break

Determined according to norm ISO 527-1:2019 on compression-molded plaques, measured 30 days after molding.

Izod Impact Resistance at 23° C. and 0° C.

Determined according to ISO180:2000 on compressed plaques according to ISO 8986-2:2009, measured 30 days after molding.

Polydispersity Index (PI)

It is believed that the polydispersity index (PI) is inversely proportional to the creep resistance of the polymer in the molten state. As used herein, the term “resistance” refers to modulus separation at low modulus value (500 Pa). The resistance was determined at a temperature of 200° C. by using a parallel plates rheometer model RMS-800, operating at an oscillation frequency which increases from 0.1 rad/sec to 100 rad/second. The parallel plates rheometer model RMS-800 was commercially available from RHEOlVIETRICS (USA). From the modulus separation value, the P.I. was calculated using the equation:

P.I:=54.6×(modulus separation)^{-1.76}

wherein the modulus separation is defined as:

modulus separation=frequency at G′=500 Pa/frequency at G″=500 Pa

wherein G′ is storage modulus and G″ is the loss modulus.

### Examples 1 and 2 and Comparative Example 1

Preparation of Solid Catalyst Component

Into a 500 ml four-necked round flask, purged with nitrogen, 225 ml of TiCl₄ were introduced at 0° C. While stirring, 6.8 g of microspheroidal MgCl₂·2.7C₂H₅OH (prepared as described in Ex. 2 of U.S. Pat. No. 4,399,054 but operating at 3,000 rpm instead of 10,000) were added. The flask was heated to 40° C. and 4.4 mmoles of diisobutylphthalate were thereupon added. The temperature was raised to 100° C. and maintained for two hours, then stirring was discontinued. The solid product was allowed to settle, and the supernatant liquid was siphoned off.

200 ml of fresh TiCl₄ were added. The mixture was reacted at 120° C. for one hour. Then, the supernatant liquid was siphoned off. The resulting solid was washed six times with anhydrous hexane (6×100 ml) at 60° C. and then dried under vacuum. The catalyst component contained 2.8 wt % of Ti and 12.3 wt % of phthalate.

Polymerization

The polymerization was carried out sequentially after a precontacting step, in two liquid-phase stirred reactors connected in series wherein liquid butene-1 was the liquid medium. During the precontacting step, the solid catalyst component, the Al-Alkyl compound triisobutylaluminum, and the external donor thexyltrimethoxysilane were pre-mixed in the relative amounts reported in Table 2. The catalyst system was injected into the first reactor, wherein the polymerization was carried out under the conditions reported in Table 2.

After the first polymerization step, the content of the first reactor was transferred into the second reactor, wherein the polymerization continued under the conditions reported in the Table 2. The polymerization was stopped by killing the catalyst and transferring the polymerized mass in a devolatilization step.

The process proceeded as described in Patent Cooperation Treaty Publication No. WO2004000895.

The copolymers were analyzed, and the results are reported in Table 3.

TABLE 2

| | | Example No. | | |
|---|---|---|---|---|
| | | 1 | 2 | Comp. 1 |
| 1^{st} reactor | | | | |
| Alkyl/butene-1 | g/kg | 0.52 | 0.52 | 0.53 |
| Alkyl/Donor | g/g | 73 | 73 | 73 |
| Temperature | ° C. | 70 | 70 | 70 |
| H₂ in bulk | ppm | 213 | 213 | 210 |
| | mol. | | | |
| Polymer in | wt. % | 12 | 12 | 12 |
| bulk | | | | |
| Hexene-1 feed | kg/h | 4.5 | 6 | 3.6 |
| Residence time | min | 141 | 141 | 140 |
| MIF | g/10′ | 23 | 21 | 25 |
| Hexene-1 | wt. % | 2.6 | 3 | 2.1 |
| 2^{nd} reactor | | | | |
| temperature | ° C. | 75 | 75 | 75 |
| H₂ in bulk | ppm | 5477 | 5477 | 5400 |
| | mol | | | |
| Polymer in | wt. % | 17 | 17 | 17 |
| bulk | | | | |
| Hexene feed | kg/h | 1.02 | 1.6 | 0.8 |
| Residence time | min | 103 | 103 | 103 |
| MIE | g/10′ | 0.5 | 0.48 | 0.5 |
| PI | — | 7.5 | 7.4 | 7.4 |
| Hexene-1 | wt. % | 2.6 | 2.9 | 1.8 |
| Split 1^{st}/2^{nd} | wt. % | 54/46 | 55/45 | 54/46 |
| reactor* | | | | |
| Total Mileage | Kg/g | 59 | 59 | 54.5 |
| | catalyst | | | |

*amount of polymer produced in each reactor

TABLE 3

| | | Example No. | | |
|---|---|---|---|---|
| | | 1 | 2 | Comp. 1 |
| Hexene | wt. % | 2.6 | 2.9 | 1.8 |
| X-ray crystallinity | % | 51 | 51 | 55 |
| Xylene soluble @ | wt. % | 3.9 | 4.3 | 2.9 |
| 0° C. | | | | |
| MIE | g/10 | 0.5 | 0.48 | 0.5 |
| | min. | | | |
| Intrinsic Viscosity | dl/g | 2.17 | 2.17 | 2.21 |
| PI | | 7.5 | 7.4 | 7.4 |
| Mw | g/mol | 531035 | 532069 | 528930 |
| Mn | g/mol | 83198 | 82113 | 83477 |
| Mz | g/mol | 1529015 | 1527310 | 1503717 |
| Mw/Mn | — | 6.4 | 6.5 | 6.3 |
| Mz/Mw | — | 2.9 | 2.9 | 2.8 |
| TmI | ° C. | 119.3 | 118.1 | 121 |
| TmII | ° C. | 107.5 | 108 | 109.7 |
| T_{c} | ° C. | 70.6 | 72.7 | 76.3 |
| Flexural Modulus | MPa | 270 | 250 | 320 |
| Tensile Strength at | MPa | 11.2 | 8.1 | 15.2 |
| yield | | | | |
| Elongation at yield | MPa | 15.7 | 15 | 15 |
| Tensile Strength at | MPa | 35 | 37.4 | 35.1 |
| break | | | | |
| Elongation at break | % | 280 | 290 | 290 |
| Izod at 23° C. | kJ/m² | 54.3 | 46.5 | 68.6 |
| Izod at 0° C. | kJ/m² | 22.9 | 37.5 | 18.9 |

1. A copolymer of butene-1 with hexene-1 having:
1) a content of hexene-1 comonomer units from 2 to 4% by weight, based upon the total weight of the copolymer; and
2) a melting temperature TmI equal to or higher than 115° C.

2. The copolymer of claim 1, having a MIE of from 0.1 to 10 g/10 min., where MIE is the melt flow index measured according to ISO 1133-2:2011, at 190° C./2.16 kg.

3. The copolymer of claim 1, having an X-ray crystallinity of from 48% to 53%.

4. The copolymer of claim 1, having a crystallization temperature T_{c}, measured by DSC with a scanning speed of 10° C./minute, of from 68° C. to 75° C.

5. The copolymer of claim 1, having a content of fraction soluble in xylene at 0° C. equal to or lower than 8% by weight, based on the total weight of the copolymer.

6. The copolymer of claim 1, having a Mw/Mn value equal to higher than 4, where wherein Mw is the weight average molecular weight and Mn is the number average molecular weight, measured by GPC analysis.

7. The copolymer of claim 1, having a Mz value of from 1,000,000 to 2,500,000 g/mol, wherein Mz is the z average molecular weight, measured by GPC analysis.

8. The copolymer of claim 1, having a Mz/Mw value from 2 to 4.

9. The copolymer of claim 1, having a flexural modulus from 200 to 300 MPa, measured according to norm ISO 178:2019 on compressed plaques, 30 days after molding.

10. The copolymer of claim 1, having a value of Izod impact resistance at 0° C. from 20 to 50 kJ/m², measured according to ISO180:2000 on compressed plaques according to ISO 8986-2:2009, 30 days after molding.

11. An article of manufacture comprising the copolymer of claim 1.

12. The article of manufacture of claim 11 being a pipe.
